(19) United States
(12) Patent Application Publication
(10) Pub. No.: US 2022/0043952 A1
(43) Pub. Date: Feb. 10, 2022

(54) Computational Platforms and Methods for Enabling CFD Simulation Processes

(71) Applicant: The University of Stavanger, Stavanger (NO)

(72) Inventor: Knut Erik T. Giljarhus, Sola (NO)

(21) Appl. No.: 17/413,057

(22) PCT Filed: Dec. 10, 2019
(86) PCT No.: PCT/EP2019/084455

§ 371 Date: Jun. 11, 2021

(30) Foreign Application Priority Data
Dec. 11, 2018 (NO) 20181586

(51) Int. Cl. G06F 30/28

(52) U.S. Cl. CPC G06F 30/28; G06F 2113/08

(57) ABSTRACT

The invention relates to a computational interface platform for enabling an execution of a three dimensional, 3-D, simulation and analysis of a 3-D model's influence on fluid dynamics by means of a computational platform. Said platform comprises the computational interface platform and a simulation platform. Said simulation platform is configured for receiving input data from the computational interface platform, executing the received input data by means of simulation program software for running a simulation process on at least one internal processing device and/or external web based processing resource, and delivering the result of the executed simulation process to the computational interface platform for e.g. 3-D presentation.

### CROSS REFERENCE TO RELATED APPLICATIONS

This application is a 35 U.S.C. § 371 national phase application of PCT/EP2019/084455 (WO-2020/120486-A1), filed on Dec. 10, 2019, entitled “Computational Platforms and Methods For Enabling CFD Simulation Processes,” which claims the benefit of Norwegian Patent Application No. 20181586, filed Dec. 11, 2018, the entire teachings of which are incorporated herein by reference in its entirety.

### TECHNICAL FIELD

The present technology relates to a simulation processes, and especially to simulation platforms and methods for enabling simulation processes.

### BACKGROUND

There are a number of simulation platforms available for use. One of said platforms is Simscale.com. This is an online simulation platform encompassing both fluid dynamics and structural mechanics. It offers a complete solution for setting up and running a simulation and visualizing the results. The user must also provide all input data by themselves. As an example, the user must know what a “k-omega SST” turbulence model is, what the SIMPLE solver is, be familiar with the concept of a grid, set all the boundary conditions for the problem etc. They try to alleviate these issues by offering a lot of online courses, webinars, etc, but it would still be a significant learning curve to use such a platform and still require a lot of time to assemble the necessary input data. The simulation software which is used by Simscale is OpenFOAM™, which is an open source for Computational Fluid Dynamics (CFD) application.

A similar platform to Simscale is Conself.com. Said platform offers less surrounding services. The platform suffers from the same issues regarding ease-of-use. Conself make use of the same simulation software OpenFOAM™.

Another simulation platform is Simulationhub.com. Said platform offers simulation applications, which are tailor made for a specific user problem, e.g. control valve designing, pedestrian wind comfort analysis. The downside of said platform is that the user still needs to provide a geometry model. For construction projects in e.g. a city, it can be a formidable task to gather. The geometry models also needs clean-up and pre-processing before being suitable for simulation.

### SUMMARY

The object of the following disclosure is to provide a solution for a number of the drawbacks of the known simulation platforms mentioned in the background section above. Especially, it is an object to provide a faster and cheaper 3-D modelling by simplifying the modelling before starting the simulation process and a suitable platform. The object is achieved by the following aspects of the invention.

According to a first aspect of the invention, a computational interface platform for enabling an execution of a three dimensional, 3-D, simulation and analysis of a 3-D model's influence on fluid dynamics by means of a computational platform is provided. Said platform comprises the computational interface platform and a simulation platform. Said simulation platform is configured for receiving input data from the computational interface platform, executing the received input data by means of simulation program software for running a simulation process on at least one internal processing device and/or external web based processing resource, and delivering the result of the executed simulation process to the computational interface platform. The computational interface platform comprises computer program software for:
connecting to a database comprising surrounding and terrestrial data;
receiving geographic data for a user specified geographic area;
Importing based on the received geographic data surrounding and terrestrial data from said database;
receiving user specified modification data;
modifying the surrounding and terrestrial data by means of said received user specified modification data;
deliver the modified surrounding and terrestrial data as input to the simulation platform
   and ordering a simulation process to start;
receiving the result of the simulation as output data;
presenting the output data of said executed simulation process.

According to a second aspect of the invention, a computational platform is provided, wherein said computational platform comprises a computational interface platform according to the first aspect of the invention.

According to third aspect of the invention, a method is provided for enabling an execution of a three dimensional, 3-D, simulation and analysis of a 3-D model's influence on fluid dynamics by means of a computational platform comprising the computational interface platform and a simulation platform. Said simulation platform is configured for receiving input data from the computational interface platform, executing the received input data by means of simulation program software for running a simulation process on at least one internal processing device and/or external web based processing resource, and delivering the result of the executed simulation process to the computational interface platform. The computational interface platform comprises computer program software for:
connecting to a database comprising surrounding and terrestrial data;
receiving geographic data for a user specified geographic area;
Importing based on the received geographic data surrounding and terrestrial data from said database;
receiving user specified modification data;
modifying the surrounding and terrestrial data by means of said received user specified modification data;
delivering the modified surrounding and terrestrial data as input to the simulation platform and ordering a simulation process to start;
receiving the result of the simulation as output data;
presenting the output data of said executed simulation process.

According to a fourth aspect of the invention, a computer program software is provided, wherein the computer program software comprises computer program code which, when run in a processor, causes a computational interface platform to perform steps of the method according to the third aspect of the invention.

According to a fifth aspect of the invention, a computer program product is provided, computer program product comprises a computer program according to the fourth aspect of the invention and a computer readable means on which the computer program is stored.

The advantage of the above suggested technical solution is that the suggested solutions provides a faster and easier modelling process than before resulting in a faster and easier total simulation handling. In addition, interactive access through an online portal interface to the results gives the user higher quality values compared to current practice

### BRIEF DESCRIPTION OF THE DRAWINGS

The foregoing, and other, objects, features and advantages of the present invention will be more readily understood upon reading the following detailed description in conjunction with the drawings in which:

FIG. 1 is a block diagram schematically illustrating a computational platform;

FIG. 2 is a flowchart of a method performed by the computational platform;

FIG. 3 is a block diagram schematically illustrating an embodiment of the computational platform.

### DETAILED DESCRIPTION

In the following description, for purposes of explanation and not limitation, specific details are set forth, such as particular circuits, circuit components, techniques, etc. in order to provide a thorough understanding of the present invention. However, it will be apparent to one skilled in the art that the present invention may be practiced in other embodiments that depart from these specific details. In other instances, detailed descriptions of well-known methods, devices, and circuits are omitted so as not to obscure the description of the present invention with unnecessary detail.

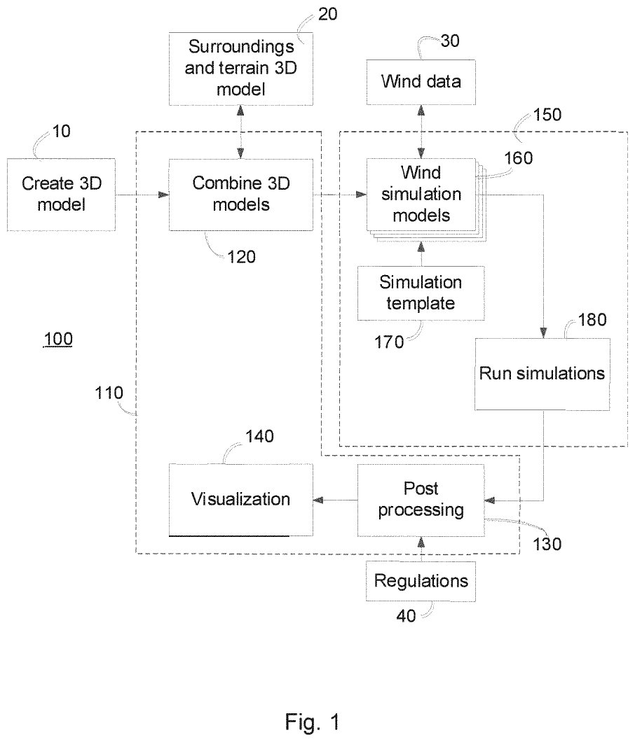

FIG. 1 is a schematic illustration of a computational platform according to the invention.

A computational platform is regarded herein as a system or arrangement of computing facilities, computer program software and processes arranged to mutually cooperate to achieve a result of data outputs and/or output signals based on input data or signals fed into the platform.

Said computational platform 100 comprises a computational interface platform 110 and a simulation platform 150. The computational interface platform 110 enables an execution of a three dimensional, 3-D, simulation and analysis of a 3-D model's, e.g. the models influence on fluid dynamics by means of the simulation platform 150 of the computational platform 100.

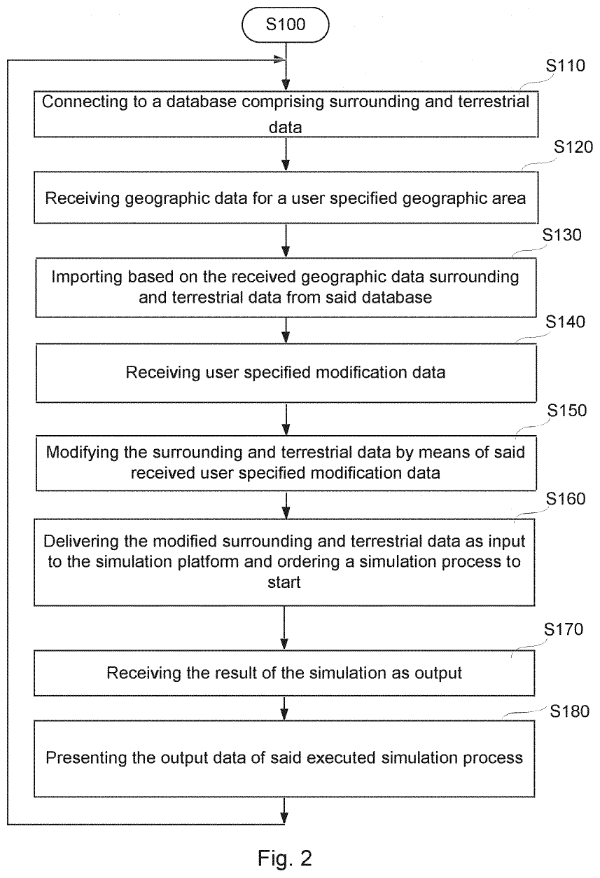

In a preprocessing stage 120 of the computational interface platform 110 a number of steps are performed which hereafter is described. Said steps are listed in a flowchart in FIG. 2. The preprocessing stage 120 may be implemented as computer program software executed on at least one internal processing device and/or external web based processing resource. The preprocessing stage 120 of the computational interface platform 110 is configured to perform the pre-processing steps S110, S120, S130, S140, S150 and S160 of a method S100 illustrated in the flowchart of FIG. 2. Said steps are now presented in more detail.

S110:—connecting to a database comprising surrounding and terrestrial data. Said database is an external database 20 comprising data for 3-D modeling of a geographic area of interest by means of the surrounding and terrestrial data stored in the external database 20. The surrounding and terrestrial data comprises at least digital elevation data, data regarding existing vegetation and structures, like buildings, etc. When a simulation process is started, the preprocessing stage 120 is configured to automatically connect, e.g. via the Internet, to one or more external databases 20 enabling 3-D modeling of geographic areas. Said database may be provided by e.g. governmental institutions and societies and accessible via Internet and online model libraries through an Application Programming Interface (API) or similar. In the illustrated example, the external database 20 comprises surrounding and terrestrial data 3-D modeling of geographic areas.

The preprocessing stage 120 is further configured to perform the step of:

S120:—receiving geographic data for a user specified geographical area. A user interface device 10, such as a Personal Computer, laptop, etc, is provided for enabling for the user to select the geographical area of interest by defining the geographical data, i.e. coordinates of the geographical area.

When the coordinates are fed in to the preprocessing stage 120 by means of the user interface device 10, the preprocessing stage 120 is configured to automatically perform the next step:

S130:—Importing based on the received geographic data surrounding and terrestrial data from said database. The 3-D model of the geographical area of interest is now loaded into the preprocessing stage 120.

In the next step, S140, the user enters user specified modification data, i.e. a 3-D model of a structure, building, etc to be inserted and merged into the 3-D model of the geographical area:

S140:—receiving user specified modification data.
S150:—modifying the surrounding and terrestrial data by means of said received user specified modification data. Thus, in S140 the 3-D model is provided by the user, and in S150, when said 3-D model is combined with the 3-D model geographical area comprising of surrounding buildings and terrain, the surrounding and terrestrial data is modified by means of said received user specified modification data.

Any of the two different 3-D models may be acquired by interfacing online model libraries through an Application Programming Interface (API) or similar.

The process of combining by merging or fusing said models is automated. For ensuring that they are suitable for the next step S160, the modified surrounding and terrestrial data may be cleaned in step S150 by removing smaller objects, closing gaps, substituting vegetation features in the terrain with sub grid parameters. When the process of merging or fusing said models together is finalized in step S150, the pre-processing stage 120 is configured for performing the step of:

S160:—delivering the modified surrounding and terrestrial data as input to the simulation platform and ordering a simulation process to start.

Said simulation platform 150 is configured for receiving the 3-D model input data from the preprocessing stage 120 of the computational interface platform 110, executing the received input data by means of a simulation program software for running a simulation processes on at least one internal or external web based processing device 180 and delivering the result of the executed simulation to the computational interface platform 110. The software may be any known software like e.g. OpenFOAM™. Further, the simulation platform 150 may comprise optional modeling modules 160 and simulation templates 170 for enabling adaptation to different simulation processes and analysis. In the illustrated embodiment of the simulation platform 150, the simulation platform 150 is configured for running Computational Fluid Dynamics (CFD) simulations and analysis. The simulation platform is configured to import data from one or more external databases 30 enabling configured simulations and analysis. In the illustrated example, the external database 30 comprises wind data. Said database may be provided by meteorological institutions and societies. Statistical wind data can be acquired for the particular location from interfacing relevant web services, e.g. as the Norwegian met office or similar.

Automated setup of the CFD simulations from all wind directions can be provided. This is based on parameterization of relevant best practice as i.e. that a limit is set to the size of the computational domain and grid based on parameters in the model of the buildings. These are mathematical relationships which are automated.

The simulation processes and corresponding computer program software are executed on at least one internal processing device 180 and/or external web based processing resource 180. By internal processing device 180 is meant a computer processor within a local computer resource and by external web based processing device 180 is a computer resource in the Internet cloud reachable via the Internet or similar. Most often, the external web based processing resource 180 offers the best computational capacity.

The illustrated embodiment is just an example, and not a limitation, of different possible simulation platforms 150, simulation and analysis possibilities to be executed on the computational platform 100.

When a simulation has been executed, the data result of the simulation is either stored in a data storage or delivered to the computational interface platform 110. Said data storage may either be a local, internal data memory with enough capacity for storing the enormous amount of output data received from the simulation platform 150. An option is to use an Internet or web based external data storage facility having enough capacity for storing the enormous amount of output data. The computational interface platform 110 is configured to perform the steps of:

S170:—receiving the result of the simulation as output data;
S180:—presenting the output data of the executed simulation process of the modified surrounding and terrestrial data.

If the output data is temporary stored in an external data storage facility , the computational interface platform 110 is configured in a modified step S170 to request said output data via an API from the external data storage facility and to receive the result of the simulation as output data. Such a request is generated when the output data of an executed simulation process is to be post-processed in stage 130 or visualized in stage 140.

Steps S170 and S180 of the method S100 are listed in the flowchart in FIG. 2.

As illustrated in FIG. 1, the computational interface platform 110 may comprise a post-processing stage 130 and may be implemented as computer program software executed on at least one internal processing device 130 and/or external web based processing resource 130. The post-processing stage 130 is configured to import data from one or more external databases 40 enabling configured post-processing. In the illustrated example, the external database 40 comprises regulation constraints for limiting the output data from the simulation platform 150. Said database 40 may be provided by providers gathering governmental and/or local society rules and regulation constraints.

Post processing might be performed to identify regions of interest for the application to be highlighted in particular for the end user. This could be based on standards and regulations for the specific application and location, e.g. highlighting regions where the pedestrian wind comfort is below the regional requirement.

When the simulation results are available, it is possible to prepare a result presentation. This is a process that might differ between the intended applications of the user. But it is automated based on mathematical and logic conditions. The applications may include, but are not limited to following applications;
i. Pedestrian wind comfort analysis
ii. Wind energy
iii. Wind pressure
iv. HVAC coefficients (Heating, Ventilation, Air Conditioning)
v. Meteorological modelling
vi. Pollution

Some of these applications require statistical analysis of the occurrence of the specific wind effects, according to the wind data (imported from the external database 30. In some cases we would also provide a before/after comparison when at new building is to be constructed and located in the geographical area of interest. This will require two runs of the process and special, but not advanced, post processing before presentation of the results.

Further, the output data of the post-processing stage 130 is thereafter delivered to the visualization stage 140 of the computational interface platform 110 or by an API to a machine/process securing and enabling deliverance of the end result both to a person (visualization) and to a machine/process (through an API). The visualization stage 140 offers a number of presentation options, but preferably the output data of the executed simulation process of the modified surrounding and terrestrial data is presented in 3-D by means of e.g. computer displays and screens.

FIG. 2 is a flowchart illustrating the method S100 for enabling an execution of a three dimensional, 3-D, simulation and analysis of a 3-D model.

The computational interface platform 110 is configured to perform the steps of:

S110:—connecting to a database comprising surrounding and terrestrial data.
S120:—receiving geographic data for a user specified geographic area.
S130:—Importing based on the received geographic data surrounding and terrestrial data from said database.
S140:—receiving user specified modification data.
S150:—modifying the surrounding and terrestrial data by means of said received user specified modification data.
S160:—delivering the modified surrounding and terrestrial data as input to the simulation platform and ordering a simulation process to start.

S170:—receiving the result of the simulation as output data;

S180:—presenting the output data of the executed simulation process of the modified surrounding and terrestrial data.

The method may be implemented in digital electronically circuitry, or in computer hardware, firmware, software, or in combinations of them. Apparatus of the invention may be implemented in a computer program product tangibly embodied in a machine readable storage device for execution by a programmable processor; and method steps of the invention may be performed by a programmable processor executing a computer program software comprising instructions to perform functions of the method by operating on input data and generating output data.

The methods may advantageously be implemented in one or more computer program software that are executable on a programmable system including at least one programmable processor coupled to receive data and instructions from, and to transmit data and instructions to, a data storage system, at least one input device, and at least one output device. Each computer program software may be implemented in a high-level procedural or object-oriented programming language, or in assembly or machine language if desired; and in any case, the language may be a compiled or interpreted language.

Generally, a processor will receive instructions and data from a read-only memory and/or a random access memory. Storage devices suitable for tangibly embodying computer program instructions and data include all forms of non-volatile memory, including by way of example semiconductor memory devices, such as EPROM (erasable programmable read only memory), EEPROM (electrically erasable programmable read only memory), and flash memory devices; magnetic disks such internal hard disks and removable disks; magneto-optical disks; and CD-ROM (Compact Disc Read-Only Memory) disks. Any of the foregoing may be supplemented by, or incorporated in, specially—designed ASICs (Application Specific Integrated Circuits).

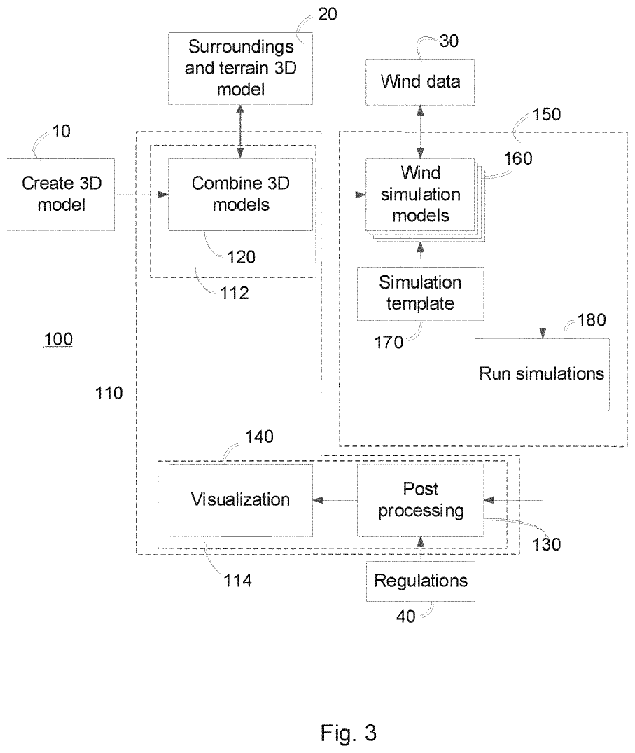

FIG. 3 is illustrating one embodiment of the computational platform 100 wherein the computational interface platform 110 is divided in a first platform interface 112 configured for delivering input data by means of the pre-processing stage 120 to the said simulation platform 150 and a second platform interface 114 comprising the post-processing stage 130 for receiving the result of the simulation as output data and presenting the output data of the executed simulation process of the modified surrounding and terrestrial data in 3-D.

A number of embodiments of the present invention have been described. It will be understood that various modifications may be made without departing from the scope of the following claims.

1. A computational interface platform for enabling an execution of a three dimensional, 3-D, simulation and analysis of a 3-D model's influence on fluid dynamics by means of a computational platform comprising the computational interface platform and a simulation platform, said simulation platform being configured for receiving input data from the computational interface platform, executing the received input data by means of simulation program software for running a simulation process on at least one internal processing device and/or external web based processing resource, and delivering the result of the executed simulation process to the computational interface platform, wherein the computational interface platform comprises a computer program software for:
connecting to a database comprising surrounding and terrestrial data;
receiving geographic data for a user specified geographic area;
importing based on the received geographic data surrounding and terrestrial data from said database;
receiving user specified modification data;
modifying the surrounding and terrestrial data by means of said received user specified modification data;
delivering the modified surrounding and terrestrial data as input to the simulation platform and ordering a simulation process to start;
receiving the result of the simulation as output data;
presenting the output data of said executed simulation process.

2. The computational interface platform according to claim 1, wherein the modification data comprises data for a user specified 3-D structure to be added to or removed from said surrounding and terrestrial data.

3. The computational interface platform according to claim 1, herein the computational interface platform comprises computer program software for post-processing the output data before presenting the output data.

4. The computational interface platform according to claim 1, wherein the simulation platform is configured to import wind data from a database.

5. The computational interface platform according to claim 1, wherein the computational interface platform comprises computer program software for post-processing the output data by means of regulation constraints before presenting the output data.

6. The computational interface platform according to claim 1, wherein the computational interface platform is divided in a first platform interface configured for delivering input data to the said simulation platform and a second platform interface for receiving the result of the simulation as output data and presenting the output data of the executed simulation process of the modified surrounding and terrestrial data by either an API or 3-D web visualization.

7. A computational platform, wherein said computational platform comprises a computational interface platform according to claim 1.

8. A method for enabling an execution of a three dimensional, 3-D, simulation and analysis of a 3-D model's influence on fluid dynamics by means of a computational platform comprising the computational interface platform and a simulation platform, said simulation platform being configured for receiving input data from the computational interface platform, executing the received input data by means of simulation program software for running a simulation process on at least one internal processing device and/or external web based processing resource, and delivering the result of the executed simulation process to the computational interface platform, wherein the computational interface platform comprises a computer program software for:
connecting to a database comprising surrounding and terrestrial data;
receiving geographic data for a user specified geographic area;
importing based on the received geographic data surrounding and terrestrial data from said database;
receiving user specified modification data;
modifying the surrounding and terrestrial data by means of said received user specified modification data;
delivering the modified surrounding and terrestrial data as input to the simulation platform and ordering a simulation process to start;
receiving the result of the simulation as output data;
presenting the output data of said executed simulation process.

9. The method according to claim 8, wherein the modification data comprises data for a user specified 3-D structure to be added to or removed from said surrounding and terrestrial data.

10. The method according to claim 8, herein the computational interface platform comprises computer program software for post-processing the output data before presenting the output data.

11. The method according to claim 8, wherein the simulation platform is configured to import wind data from a database.

12. The method according to claim 8, wherein the computational interface platform comprises computer program software for post-processing the output data by means of regulation constraints before presenting the output data.

13. The method according to claim 8, wherein the computational interface platform is divided in a first platform interface configured for delivering input data to the said simulation platform and a second platform interface for receiving the result of the simulation as output data and presenting the output data of the executed simulation process of the modified surrounding and terrestrial data by either an API or 3-D web visualization.

14. A computer program comprising computer program code which, when run in a processor, causes a computational interface platform to perform steps of the method according to claim 8.

15. A computer program product comprising a computer program according to claim 14 and a computer readable means on which the computer program is stored.
